(19) United States
(12) Patent Application Publication
(10) Pub. No.: US 2006/0114757 A1
(43) Pub. Date: Jun. 1, 2006

(54) Method and device for reproducing multi-track data according to predetermined conditions

(76) Inventors: Wolfgang Theimer, Bochum (DE); Knut Haberland-Schlosser, Bochum (DE); Peter Weingart, Bochum (DE); Reza Serafat, Bochum (DE); Matthias Luck, Dortmund (DE); Udo Gortz, Bochum (DE); Klaus Rateitschek, Bochum (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/519,810

(22) PCT Filed: Jul. 4, 2002
(86) PCT No.: PCT/IB02/02614

§ 371 Date: Oct. 3, 2005

(51) Int. Cl. G11B 21/08

(52) U.S. Cl. 369/30.01

(57) ABSTRACT

A mass storage, an electronic multi-track reproducer, and a method to reproduce multi-track data are shown. The possibility is provided to change the reproduction medium according to present environmental conditions, e.g., to change from a text reproduction seamlessly to the reproduction of a radio play, in case environmental conditions indicate that the user is actually not capable of reading because of vibrations or illumination that is too low. To provide these features to a user, a mass storage, a multi-track reproducer, and a method for reproducing the tracks according to detected environmental conditions is provided. The invention is based on multi-track data, wherein at least a subset of the tracks is sufficient for a basic perception of the data, and at least two of the tracks are provided with synchronization markers. The reproduction can seamlessly jump between the different tracks and reproduction modes, as the tracks are synchronized by the markers.

### CROSS-REFERENCE TO RELATED APPLICATION

This application is the U.S. National Stage of International Application Number PCT/IB2002/002614 filed Jul. 4, 2002 and published in English on Jan. 15, 2004 under International Publication Number WO 2004/006209 A1.

### BACKGROUND OF THE INVENTION

1. Technical Field

The present invention relates to electronic playback devices in the field of electronic books having a storage and a display. It also relates to playback devices that are able to adapt the playback mode to context related conditions. More specifically the invention relates to a simple method to adapt the playback mode of a playback device automatically to external conditions related to the use of the device, where a conventional user controlled playback device requires manual input or does not provide such an option at all.

2. Discussion of Related Art

An electronic book (e-book) is usually the electronic equivalent of a printed book, i.e. it contains the text and the illustrations of a book in an electronic format, readable on displays. An audio book (a-book) on the contrary contains the content of a book in an audio format and can be listened to. A video book (v-book) is a portable video playback device and the visual based counterpart of a portable cassette or CD-player.

Both types of literature presentation focus on special aspects and enhance the user's experience:
An e-book is portable and compact.
The a-book concentrates on the audio presentation of the content, also permitting easy portability and advantages for language training or radio plays.
The v- Book concentrates on video presentation of the content also permitting easy portability and advantages for language training or movies.

The state of the art in e-books is provided e.g. by European Patent Application EP 1 158 822 A2, disclosing a mobile terminal device and a method to remotely access location relevant data via a mobile terminal device using a mobile telephone network. It more or less discloses a kind of location sensitive remote controlled tourist guide cross reference list. The disclosed methods are not capable of being operated in a mobile device environment alone, and require a remote database system in the background.

Another example of a portable e-book is provided by U.S. Pat. No. 5,991,594. The document basically discloses a mobile electronic device using single text data and a text to speech processor, to provide some kind of a read out feature to an electronic book.

Another European Patent Application with the number 1 172 739 A2 relates to the field of downloading and billing of electronic books from a server. The key element in this document is to transfer encoded data via a video signal from a distributor to a user.

All the above approaches for an e-book have in common that the replay of data is more or less a single action replay for a single data track.

Currently, E-books and a-books are slowly gaining market share. Mass storage devices offer the capability to contain an almost complete multimedia presentation of literature/music and film.

In earlier approaches the different tracks of the proposed e-book have formed completely different media solutions, namely a conventional book, an audio or music recording or a video. The main disadvantage of the conventional system is that a user can not freely select between different kinds of representations to be played back. So in a conventional data carrier only a video, a book or a radio play is stored. The maximum choice provided to a user is delivered by DVD players that can offer different sets of audio tracks, and subtitles to a single video/movie.

Conventional DVD players offer a change of audio tracks even during a playback operation. But they do not provide a possibility to automatically change e.g. audio tracks.

So far no e- or a-book device offers a feature to adapt a presentation and a presented content to environmental conditions and user preferences.

### DISCLOSURE OF INVENTION

So it would be desirable to have a media player of an electronic book capable of adapting the presentation and the presented content to environmental conditions.

It is further desirable to have a mobile electronic device capable of automatically adapting a presentation or a presented content to environmental conditions.

It is further desirable to have an e-, a- and v-book concept providing a deeper interaction between the content of the book and the user.

It is further desirable to have an e-, a- and v-book enabling an adaptation of the presentation to the user's environment as well as to the preferences of a user.

It is another aspect of the present invention to improve e-, a- and v-books, using a mass storage device.

It is desirable to have a mass storage being capable of providing multiple data that can be recalled in accordance with external conditions.

According to a first aspect of the present invention a mass storage is provided, comprising multiple tracks of information, wherein a subset of said tracks is sufficient for basic perception such as reading, listening and watching, respectively following audio, video or text reproduction. The mass storage is characterized in that at least two of said tracks comprise synchronization markers, to enable a seamless change between said tracks during reproduction. In contrast to a bilingual stereo video cassette, of the state of the art, the present invention enables a use of arbitrary information on said tracks. Basically, in case of an e-book a first track can be the classic text data, and the additional tracks can be audio data such as a radio play or a background soundtrack. In contrast to standard video tapes the tracks in a modern mass storage need not be locally synchronized. So the single tracks may be coded in a space division multiplex pattern on a single digital data track.

In an embodiment of the present invention, said synchronization markers are to enable a time synchronization of said different tracks during reproduction.

In another embodiment said synchronization markers are to enable a logical synchronization of data within the tracks. In this case the synchronization markers are to provide a possibility to extract a single data content from a certain data track, for example to extract only the text spoken by Romeo in Shakespeare's Romeo and Juliet from the script book.

In another embodiment of the present invention said synchronization markers comprise an information about the storage location of other tracks. In this case the synchronization markers are to provide e.g. cross references to background information in the mass storage.

In another embodiment of the present invention, at least one of said tracks has a different length than the other. Thereby it is indicated that the stored data is not present in a classical continuous parallel recording pattern as known from multi-track audio recordings in recording studios.

In yet another embodiment of a mass storage, at least one of said tracks comprises at least one hyperlink. In this case the synchronization markers are to provide e.g. cross references to background information in the mass storage or in a communication network such as the internet. If the hyperlinks comprise cross references to internet pages it should be ensured that the pages are provided by the distributor to the mass storage, at least for an average or expected lifetime of said mass storage.

In another embodiment of the present invention, there are data stored on said mass storage to relate the reproduction of said tracks to predetermined rules. The rules can include prescriptions of the reproduction of said tracks, as e.g. pre-configured reproduction modes. The rules can stop the reproduction of a visual content e.g. on the front seats of a vehicle, to prevent accidents by visually detracted drivers. The data can also be used to configure a relation between environmental conditions and the tracks to be reproduced.

In summary, one can say that the mass storage can be embodied as a storage medium with multiple synchronized tracks of book information stored, for example:
A text with formatting and layout information,
Spoken voices, may be separated for the different speakers,
Background audio sounds, i.e. all non-voice audio information like e.g. environmental sounds, music, and the like,
Video sequences providing illustrations, animated scenes or complete movies without sound, and
Hyperlinks which become active at some point in time on the track and provide additional information which can be accessed on request.

The content of a linked URL can either be stored locally on the mass storage medium or be stored remotely e.g. in the Internet.

According to another aspect of the present invention an electronic reproduction device is provided. The electronic reproduction device comprises a multi-track reproducer, for reproducing stored multi-track reproduction data. The electronic reproduction device is characterized by a component to adapt the reproduction of said tracks to predetermined conditions, said adaptation component being connected to said reproducer and being adapted to operate a seamless change of the reproduction between two tracks having synchronization markers. Basically, the electronic device is a media player to reproduce data stored on a media according to external conditions. In contrast to conventional media players where a user can pre-select certain tracks for the reproduction, the present invention uses a set of predetermined conditions to automatically adapt the reproduction mode to actually present conditions. In a basic embodiment of the present invention the reproduction device may adapt the reproduction settings to the time of day, e.g. change the brightness of a screen and the volume according to expected background noise and expected stray light. The conditions may also comprise the detection of synchronization markers on the tracks, whereby the reproduction is changed between the tracks at the location of the two related synchronization markers operated by the reproducer and connected adaptation component.

In another embodiment related to the latter feature of the adaptation component the present invention is characterized in that said adaptation component is configured to automatically change the tracks during reproduction. The state of the art only allows it to change the reproduced tracks according to user input. The present invention enables a user e.g. to reproduce a text or a video in a bilingual mode. Thereby, a device can provide different reproduction modes such as spoken text for selected parts of a stage play and a subtitle only depiction for a selected role in the play, enabling e.g. an actor to learn a role quickly and efficiently.

In yet another embodiment, said adaptation component is configured to automatically change the reproduction of said tracks during reproduction. This is to adapt the reproduction and device settings such as loudness/brightness of the display, to detected environmental conditions. The device can be configured to control the reproduction in accordance with a currently used power supply, e.g. turn to a text mode to guarantee that a user can finish a started reproduction, and return to a video reproduction, if reconnected to a power supply.

In another embodiment of the present invention the electronic reproduction device further comprises at least one sensor connected to said adaptation component for detecting environmental conditions. A sensor can be used to detect external operating conditions enabling the device to determine external conditions by itself. The use of internal sensors provide a stand alone operability to the device.

In yet another embodiment one of said sensors is an illumination sensor. Thereby the device can decide by itself how to set the brightness and the intensity of a monitor or a display. In case that the brightness is detected as being too low, the device may change to a video reproduction mode or to an audio-only (radio play) reproduction mode.

In another embodiment, one of said sensors is an acceleration sensor. The multi-track book can be fitted with acceleration sensors. An acceleration sensor in the mobile terminal can be used for explicit user input. Tilting the device e.g. could mean to turn the page back and forth. But longer measurements of the sensor also allow an educated guess on the environmental conditions: Often or longer accelerations indicate being on the move where reading from a display becomes more difficult. Switching to the audio tracks, or an increased character size would be the system's recommendation. An acceleration sensor can also be used to provide an acceleration controlled display stabilization, or an adaptation of monitor clock frequency to external illumination to prevent beat interference so that a user can also use the device without perceivable flicker.

In yet another embodiment, one of said sensors is an acoustical sensor. the acoustical sensor can comprise a microphone for audio measurements. The user can conveniently listen to the audio tracks if there is no or a low level of ambient noise. If the noise level increases, sensed by the built-in microphone, the audio signal is also amplified. In case a headphone is used, this may be used to provide an active noise suppression to the headphone. But if the ambient noise exceeds a user defined upper threshold, the presentation switches to text and graphics without audio playback. The user defined threshold may be determined by evaluating a user behavior pattern. In addition, a speech recognizer can be utilized to accept voice input to navigate through the content of the mass storage. The acoustical sensor can be used to provide a training device for actors to cite a predetermined text passage. The training device can detect the right acoustical input e.g. by an acoustical pattern or envelope recognition e.g. metre recognition. Such a device may also be used as a partially automated language lab, for teaching a foreign language to pupils.

In another embodiment, one of said sensors is a position sensor. The location sensor can be an absolute or a differential GPS location sensor, wireless beacon controlled navigation or location sensor e.g. within a museum, or a position sensor to detect the current orientation of the device.

Location-dependent presentation of content allows “reality books”. If a positioning sub-system (e.g. via GPS or BT beacons) provides position information a user could e.g. walk through a historic scenery or a museum and get only those portions/episodes of the book which are relevant at the current position. So the present invention can provide an electronically activated tourist guide.

In yet another embodiment one of said sensors is an optical sensor. The optical sensor can be a vision system to detect environment conditions and additionally the attention and the identification of a user. A vision system can be used to automatically recognize a user and automatically reload preferred settings of said user. The book looks at a user when activated, and recalls the page the user has put the book aside, if it recognizes the user.

In another embodiment, one of said sensors is an electrical sensor, to detect interfaces, docking stations and other electrically perceivable environmental or operational state conditions. With an electrical interface the device may store data transmitted via said interface. The electrical sensor can be used to determine e.g. the battery condition.

In another embodiment, the electronic reproduction device comprises an interface to connect external devices to said reproducer. The interface can be an interface for a communication network or a slot for a slot-in memory or a mass storage.

In yet another embodiment the electronic reproduction device comprises a built in mass storage connected to said reproducer. The mass storage can be e.g. a hard disc drive or a comparable mass storage. The interface described in the previous paragraph, can also be an interface to connect to a docking station, for downloading data to a built in mass storage.

In another embodiment of the present invention the electronic reproduction device comprises a communication device. The device can comprise a radio (as an example for a one way communication).

In an additional embodiment of the present invention, said communication device comprises a mobile telephone. The use of the invention with a mobile telephone is particularly of interest, as the spread of mobile phones in the last years will lead to an increased demand for multi purpose mobile telephones, as users will probably not accept to carry and maintain more than one electronic device with them at a time. So the future will show a single device with multiple playback and record functionality that can be used to phone and to browse the internet and the like.

It should be noted that the device may further comprise a media recorder, and additional features such as a synchronization marker editor, to enable a user to interconnect two distinct data tracks with a common synchronization pattern.

In summary one can say that the present invention can be embodied such that the user can determine the way the m-book presents the content:
Either pure textual, audio or audio-visual or video presentations can be selected by the user.
The user could assume one role in a plot and eliminate that role from the textual or audio/video presentation. This would enable a mixture of text and e.g. the presentation of one's own role as spoken text.

In addition to user preferences the m-book presentation can automatically adjust to environmental conditions for better perception. Examples for this behavior are
The m-book switches to pure audio while the user is on the move, e.g. sensed by an acceleration sensor.
If the surrounding noise increases, also the volume of the audio track is increased or switching to pure text is done.

According to another aspect of the present invention, a method for reproducing stored multi-track reproduction data accordance with predetermined conditions is provided. The method comprises identifying of predetermined conditions, and automatically adapting the reproduction of said tracks to said predetermined conditions. The identification of a predetermined condition and the adaptation of a reproduction of selected tracks represent a relation of an operational state to predefined internal or external conditions.

In another embodiment of the present invention, the method further comprises relating said predetermined conditions to rules concerning the reproduction of said multi-track reproduction data. The establishing of a set of rules may be embodied by generating a relation between conditions and the reproduction of the tracks. The relation may be embodied by a matrix like association between the conditions and the reproduction.

In another embodiment of the present invention, the method, further comprises the detection of environmental conditions. The adaptation of the reproduction according to predetermined conditions include the adapting to environmental conditions.

According to another aspect of the present invention, a software tool capable of carrying out the methods of the preceding description is provided, which comprises program code means for performing all of the steps of the preceding description when said software tool is incorporated in a program which is run on a computer or a network device.

According to yet another aspect of the invention, a computer program is provided comprising program code means for carrying out the aforementioned methods of the preceding description when said computer program is run on a computer or a network device.

According to yet another aspect of the invention, a computer program product is provided comprising program code means stored on a computer readable medium for carrying out the method of the preceding description when said program product is run on a computer or a network device.

### BRIEF DESCRIPTION OF THE DRAWINGS

In the following, the invention will be described in detail by referring to the enclosed drawings in which:

FIG. 1 is an example of different tracks stored on a single mass storage, wherein the single tracks are interconnected by synchronization markers, and

FIG. 2 is an example according to FIG. 1 with a different layout of a single track, and

FIG. 3 is an example of a mobile device capable of playing back a single content in many different presentations, according to pre-selected or detected conditions.

### BEST MODE FOR CARRYING OUT THE INVENTION

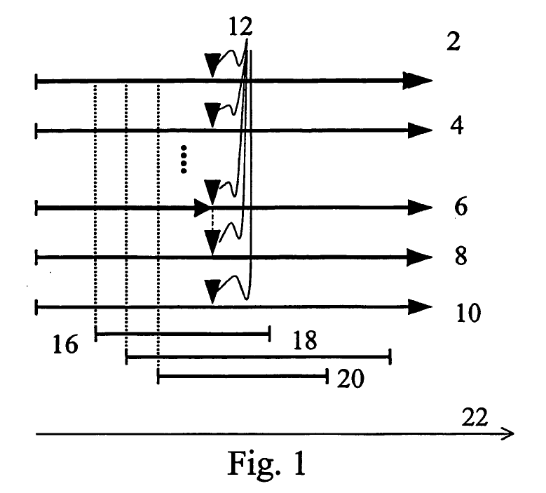

FIG. 1 is an example of a multi-track document stored on a mass storage according to one embodiment of the present invention. Considering a mass storage medium with a storage capacity of 1 GB or beyond, such a memory medium could be used to store the content of a book only in a small fraction of the memory space including text and layout information. It would be a waste of resources not to fill the memory space with additional information such like a whole library. The library solution has the drawback that a user maybe does not want to pay for a complete edition. One solution would be to provide an all-in-one document comprising different aspects of a single piece of literature. So it may be helpful to incorporate not only different language versions of a single book on one storage medium, but also different presentations of a single theme. So it is possible to combine different lingual versions of a book together with different radio play versions of the same book. So in the end it may be possible to have one mass storage comprising the book, translations thereof, a (multilingual) comic strip version, a radio play version, a (computer) animated cartoon and a real film version of a single theme in one mass storage. This alone is an inventive idea, as until now there are no storage media and media player capable of providing a complete adaptation of a single theme. Presently, the different presentations are restricted to talking books and DVD films with different language and subtitle versions. Presently, talking books are produced among other things for blind persons. Presently, there is no storage media known that can be used by healthy, blind and deaf persons.

In FIG. 1 there are multiple different data tracks 2, 4, 6, 8, 10 stored. Additionally hyperlinks 18 are provided to provide additional information. The tracks 2 to 10 each have synchronization markers 12 to synchronize the tracks 2 to 10. In FIG. 1 the track 2 can be a standard text track as in the case of conventional e-books. The track 4 can be e.g. a talking book text in one or more languages. Preferably the voice tracks are subdivided in speaker parts for each protagonist in the book or in the text. Other audio tracks can comprise background music and background audio. If played together, the audio tracks can form a complete radio play. The track number 6 can be a subtitle track comprising screenplay and texts and stage directions. The track 8 can be an audio track of a film version of the present book. If desired there can be additional tracks 10 such as various translations, subtitles, comic strip versions of the book, an animated film or a movie.

A short list of examples of those tracks 2, 4, 6, 8, 10 can be:
different language translations of the same book for different markets
inclusion of an audio version synchronized with the textual information
linking of graphics, audio and video clips to relevant portions of the text and partly automatic playback when the respective text passages are encountered.
inclusion of a story board or comic strip version synchronized with the textual information
inclusion of a video version synchronized with the textual information

So one embodiment of the present invention enables the user to change the reproduced track seamless at each synchronization marker 12. as indicated by the bold arrow 2 and the bold elements of track 6 changing to track 8 at the synch marker 12. This change can indicate e.g. a use of said reproduction to train an actor for his role e.g. by playing the story book and changing to subtitles if the role to be trained has a speech part. This would be an ideal role trainer for actors.

Another application of the present invention includes the monitoring of external conditions such as illumination, vibrations and noise. If a device can recognize environmental conditions the device itself can decide which would be the best way to continue the reproduction. In case of a combination of an e- and an a-book, an ea- or multi-track (m-) book, the book can change from text to radio play in case the book detects being inside a vehicle, so a driver of a car can seamlessly follow the story of the book, even if he is getting in his car and drives around. In case of an eav-book, a combination of a video player, an audio book and an e-book, the device can change from radio play to video reproduction if it detects that the car is parked.

So the present invention deals with a new approach for multi-modal interactive electronic books and an improved user experience of e-books under various environmental conditions.

The e-book concept of an IPR (Intelligent Personal Reader) comprises multiple synchronized tracks of information (textual, graphics, audio, . . . ) where a subset of those tracks is sufficient for basic consumption. For example the text alone would constitute a complete e-book. But those basic tracks can be enhanced by additional information like audio background sounds, music or voices, complemented by graphics or hyperlinked information 16, 18, 20 in a storage or the Internet to improve the user experience. In addition the e-book is interactive by adjusting to the environmental conditions e.g. by increasing the audio volume in a noisy environment or switching off audio, and turning to subtitles or text when a background noise level is detected that is quoted to be too high.

But now those different channels of information are integrated and can be combined on user request and based on environmental conditions. The invention improves the user experience and immersion into the plot of a story by offering additional channels and background information. A user reading a jungle story e.g. can be complemented by fitting sounds (e.g. jungle themes), short music or video clips can be integrated. The arrow 22 is to indicate the direction of time the reproduction of the tracks are to follow.

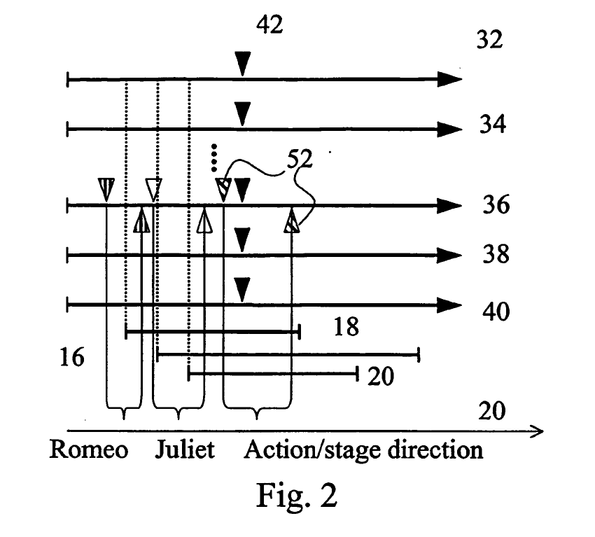

FIG. 2 is an example of multiple tracks according to FIG. 1 with a different layout of the single tracks. As in the case of FIG. 1 there are different tracks 32, 34, 36, 38, 40. The only difference is that track 36 is provided with additional synchronization markers to indicate certain speech roles and stage directions within a single script track 36. The synchronization markers 50 indicate the different synchronization markers to use a single text track to extract subtitles background information for deaf people from the film script. The arrow 22 is to indicate the direction of time the reproduction of the tracks are to follow. As in FIG. 1 the tracks can further comprise hyperlinks 16, 18, 20 to background information or e.g. to internet pages.

All tracks contain hidden synchronization markers 42 which permit synchronized playing of combined tracks, e.g. a full movie with video and audio tracks as well as text sub-titles (even in a different language than the audio track). The separation of voices on different tracks also allows easy spatial positioning for headphone reproduction: the different monaural voice signals are simply filtered differently for the left and the right headphone speakers. The spatial positioning information can be integrated into the audio tracks e.g. using a XML-based markup language (VRML, . . . ). In the following the links between multi-track storage and interactive content as well as adaptation of the presentation to the environment are discussed.

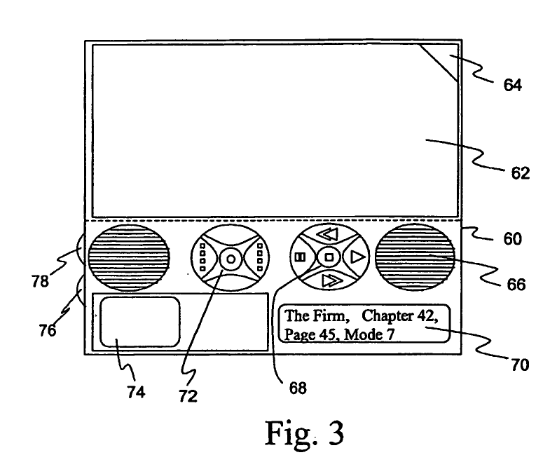

FIG. 3 is an example of a mobile device capable of playing back a single content in many different presentations, according to pre-selected or detected conditions. The depicted e-a- and v- book is shortly denoted as m-book 60 (short for multi-track electronic book). The m-book 60 has a main display screen 62 and a turnover/bookmark/dog-ear key 64. Basically, the screen and the turnover key would provide sufficient interaction for a single e-book. As in the case of a conventional book, a user can leaf through the pages of the e- book by pressing key 64. The key 64 can be embodied as a part of a touch screen display.

To provide a more sophisticated m-book functionality additional loudspeakers 66 are provided in the m-book. To enable a better usability in the multi-track operation mode, an additional index display 70 is provided to indicate the actual position within the book. The m-book further comprises a sensor field 72 with optical and acoustical sensors to enable the m book to automatically adapt to external environmental conditions. The sensor field can comprise a microphone for audio measurements. The user can listen to the audio tracks well if there is no or a low level of ambient noise. If the noise level increases, sensed by the built-in microphone, the audio signal is also amplified. But if the ambient noise exceeds a user defined upper threshold the presentation switches to text and graphics without audio playback. In addition a speech recognizer can be utilized to accept voice input to navigate through the content.

The sensor field can comprise sensors for the adaptation of the presentation to a present environment. As already indicated in the beginning, the mobile use of m-books is challenging since all modalities of presentation have drawbacks in certain situations. It is claimed here that the intelligent use of different tracks of information can partly compensate for that by taking into account user preferences and sensor measurements.

The m-book can be fitted with acceleration sensors. An acceleration sensor in the mobile terminal can be used for explicit user input. Tilting the device e.g. could mean to turn the page back and forth. But longer measurements of the sensor also allow an educated guess on the environmental conditions: Often or longer accelerations indicate being on the move where reading from a display becomes more difficult. Switching to the audio tracks, or an increased character type would be the system recommendation.

The m-book can comprise sensors e.g. for scanning of external interfaces or surfaces. If the terminal scans external interfaces e.g. to the home stereo system or a video projector / TV screen it could automatically activate audio or video tracks to be played back by external devices. Simply putting the terminal into an audio/video cradle would initiate a switch from textual presentation to audio/video playback.

An optical scanning device can be used to identify a user in accordance with a pre-stored user database, with the help of bio-metric data. The scanning of a user face can also be used to track the eye movement of the user to provide an automatic turnover feature.

The m-book further comprises a slot 74 to insert a mass storage device. It may be noted that the m-book may be enabled to reproduce single track storage media, too.

The two adjusting wheels 76, 78 on the left side of the m-book can be scroll wheels to adjust the brightness of the screen, the loudness of an audio track reproduced, or a scroll wheel as known from a computer wheel mouse to scroll through a text.

The first crude interaction with an m-book permits the user to switch on or off selected tracks in order to concentrate on the text or the audio information by using the interaction pad 68, an on-screen display, or a touch screen display. But the content presentation can become more dynamic by integrating external trigger conditions:
Depending on the time of day/year different episodes could be presented. If e.g. the evening is coming in reality, also the book chapter provides a description of an evening scene. This makes it easier for the user to immerse into the book fully.
Location-dependent presentation of content allows “reality books”. If a positioning sub-system (e.g. via GPS or BT beacons) provides position information a user could e.g. walk through a historic scenery and get only those portions/episodes of the book which are relevant at that position. So the present invention provides some kind of an electronically activated tourist guide.
If the user takes a photo of a certain spot a multimedia search on the mass storage device could only present background information which is valid for that image content.

The e-book concept described herein comprises multiple synchronized tracks of information (textual, graphics, audio, . . . ) where a subset of those tracks is sufficient for basic consumption. For example the text alone would constitute a complete e-book. But those basic tracks can be enhanced by additional information like audio background sounds, music or voices, complemented by graphics or hyperlinked information in the Internet to improve the user experience. In addition the e-book is interactive by adjusting to the environmental conditions (e.g. increasing audio volume in a noisy environment or switching off audio while the background noise level is too high).

It should be noted that the m-book 60 of FIG. 3 can further comprise a mobile communication device. The mobile m-book 60 can be a sub-element of a mobile telephone such as e.g. the Nokia Communicator™ device providing a suitable display for an m-book functionality. In this case the m-book 60 of FIG. 3 does represent an inner surface of an unfolded clamshell-like mobile phone. It should further be noted that the m-book 60 can comprise another suitable communication element such as a Bluetooth™ connection or a Network connection to a communication network such as the internet. A communication feature can enable a device to download not only a whole multi-track document, but would enable a user to download only a single additional track to a multi-track document the user has purchased earlier. So if a user has already a text track, a video track and a sound track of a document in e.g. an English version, and wants to have an additional subtitle track e.g. in Finnish, the user can download only this single track and pay only for this single track. Thereby, it is no longer necessary for the manufacturers of multi-track data carriers to decide which tracks have to be arranged on a data carrier to fit the demands of the greatest possible group of customers.

The invention can be used in entertainment and media terminals, especially if a mass storage solution is integrated into the device. Memory sticks, multi-media cards (MMC Card) and hard disc drives (Micro-Drive) can be used as storage media according to the actual state of the art in the field of storage technique.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Mass storage comprising multiple tracks of information, wherein said tracks have different kinds of data contents, wherein a reproduction of a subset of said tracks is provided for basic perception, characterized in that at least two of said tracks comprise synchronization markers, to enable a seamless change between said tracks during reproduction.

2. Mass storage according to claim 1, wherein said synchronization markers are to enable a time synchronization of said different tracks during reproduction.

3. Mass storage according to claim 1, wherein said synchronization markers are to enable a logical synchronization of data within the tracks.

4. Mass storage according to claim 1, wherein said synchronization markers comprise an information about the storage location of other tracks.

5. Mass storage according to claim 1, characterized in that at least one of said tracks has a different length than another one.

6. Mass storage according to claim 1, wherein at least one of said tracks comprises at least one hyperlink.

7. Mass storage according to claim 1, characterized by data to relate the reproduction of said tracks to predetermined rules.

8. Electronic reproduction device, comprising a multi-track reproducer, for reproducing stored multi-track reproduction data wherein said tracks have different kinds of data content, characterized by a component to adapt the reproduction of a subset of said tracks to predetermined conditions, said adaptation component being connected to said reproducer, and being adapted to operate a seamless change of the reproduction between two tracks having synchronization markers.

9. Electronic reproduction device according to claim 8, characterized in that said adaptation component is configured to automatically change the tracks during reproduction.

10. Electronic reproduction device according to claim 8, characterized in that said adaptation component is configured to automatically change the reproduction of said tracks during reproduction.

11. Electronic reproduction device according to claim 8, characterized by at least one sensor connected to said adaptation component for detecting environmental conditions

12. Electronic reproduction device according to claim 8, wherein one of said sensors is an illumination sensor.

13. Electronic reproduction device according to claim 8, wherein one of said sensors is an acceleration sensor.

14. Electronic reproduction device according to claim 8, wherein one of said sensors is an acoustical sensor.

15. Electronic reproduction device according to claim 8, wherein one of said sensors is a location sensor.

16. Electronic reproduction device according to claim 8, wherein one of said sensors is an optical sensor.

17. Electronic reproduction device according to claim 8, wherein one of said sensors is an electrical sensor.

18. Electronic reproduction device according to claim 8, characterized by an interface to connect to said reproducer.

19. Electronic reproduction device according to claim 8, characterized by a built-in mass storage connected to said reproducer.

20. Electronic reproduction device according to claim 8, characterized by a built in communication device.

21. Electronic reproduction device according to claim 20, wherein said communication device comprises a mobile telephone.

22. Method for reproducing stored multi-track reproduction data in accordance with predetermined conditions, wherein said tracks comprise different kinds of data content, comprising:
identifying said predetermined conditions, and
automatically adapting the reproduction of a subset of said tracks to said predetermined conditions.

23. Method according to claim 22, further comprising relating said predetermined conditions to rules concerning the reproduction of said multi-track reproduction data.

24. Method according to claim 22, further comprising detecting environmental conditions, and wherein said adapting to predetermined conditions include the adapting to environmental conditions.

25. Software tool comprising program code means for carrying out the steps of claim 22 when said program is run on a network device or a mobile terminal device.

26. Computer program comprising program code means for carrying out the method of claim 22 when said program is run on a computer or network device.

27. Computer program product comprising program code means stored on a computer readable medium for carrying out the method of claim 22 when said program is run on a network device or a mobile terminal device.
